(19) United States
(12) Patent Application Publication
(10) Pub. No.: US 2012/0156757 A1
(43) Pub. Date: Jun. 21, 2012

(54) PURIFICATION OF IMMUNOGENS USING A NON-POLYSACCHARIDE MATRIX

(75) Inventors: Ganapathysubramanian Iyer, Woburn, MA (US); Joaquin A. Umana, Stoneham, MA (US); Neil Soice, Amherst, NH (US)

(73) Assignee: Millipore Corporation, Billerica, MA (US)

(21) Appl. No.: 13/324,464

(22) Filed: Dec. 13, 2011

Related U.S. Application Data
(60) Provisional application No. 61/423,280, filed on Dec. 15, 2010.

(51) Int. Cl. C12N 7/02; C07K 1/18; C07K 14/155; C07K 14/11; C07K 14/035; C07K 14/005; B01D 15/36

(52) U.S. Cl. 435/239; 530/413; 521/27

(57) ABSTRACT

The present invention relates, at least in part, to novel and improved chromatography matrices for separating or purifying immunogens, such as, for example, viruses and viral surface proteins, from one or more contaminants in a sample, where the matrix comprises a porous non-polysaccharide solid support comprising a negatively charged, multivalent ion exchange group directly attached to the solid support.

### PRIORITY

This application claims the benefit of priority of U.S. Provisional Patent Application No. 61/423,280, filed on Dec. 15, 2010, the entire contents of which are incorporated by reference herein.

### FIELD OF INVENTION

The present invention relates, at least in part, to novel and improved processes for purification of immunogens, including, but not limited to viruses, viral surface proteins and immunogenic fragments thereof, using a non-polysaccharide matrix.

### BACKGROUND

Following the production of immunogenic biomolecules such as, for example, viruses and therapeutic proteins in mammalian host cells or eggs, it is desirable to separate the biomolecule from other components of the host cells or eggs, such as, for example, DNA, RNA and host cell proteins, in order to obtain a substantially pure population of the biomolecule, which is especially key when it comes to biomolecules that need to undergo FDA approval.

Conventionally, a variety of techniques such as ultra-centrifugation, chromatography and membrane filtration are used to purify and concentrate immunogens such as, for example, viruses and therapeutic proteins (see, e.g., PCT Publication Nos. WO2008/073490 and WO2004/112707). The various types of chromatography techniques which have been used to purify such biomolecules include, for example, size exclusion (SEC), anion exchange (AEX) and affinity chromatography (see, e.g., WO2004/112707; Transfiguracuin et al., J Virol Methods 142:21-28 (2007); and Kalbfuss et al. Biotech. Bioeng. 96:932-944 (2007)).

Additionally, a number of bead-based approaches have been described for the purification of immunogens such as viruses, which typically employ porous beads packed in a column for the purification and concentration of viruses. These include beads functionalized with affinity ligands such as, for example, lectins and pseudo-affinity ligands such as heparin. However, since viruses cannot access the internal surface area of most commercially available beads due to the size limitation, the capacity of such beads for virus purification is most often dependent on the external surface area of the beads. One solution to the use of porous beads for the purification of immunogens such as viruses has been to use smaller size beads, however, this typically results in larger pressure drops across the purification column which is undesirable.

More recently, pseudo-affinity membrane-based approaches have been described for the concentration and purification of immunogens such as viruses. However, most of such membranes are described as being polysaccharide based and also do not appear to have optimal properties for virus purification.

### SUMMARY OF THE INVENTION

The present invention provides novel and improved methods of purification of immunogens including, e.g., viruses and viral surface proteins or immunogenic fragments thereof, which involve the use of a synthetic non-polysaccharide matrix. In a particular embodiment, the virus is an influenza virus. In other embodiments, the virus is a herpes simplex virus or a human immunodeficiency virus.

In some embodiments, a chromatography matrix for purification of an immunogen such as, e.g., a virus or a viral surface protein or immunogenic fragment thereof is provided, where the matrix comprises a porous non-polysaccharide solid support (e.g., a porous polymeric membrane) which comprises a negatively charged, multivalent ion exchange group directly attached to the solid support (e.g., a porous polymeric membrane) al a density of at least 0.1% weight of the solid support (e.g., a porous polymeric membrane), where the matrix comprises a higher binding capacity and/or impurity removal capacity relative to a polysaccharide matrix comprising a multivalent ion exchange group attached to the matrix.

In some embodiments, a matrix (e.g., a porous polymeric membrane) according to the present invention comprises a higher binding capacity and/or impurity removal capacity relative to a non-polysaccharide bead comprising a multivalent ion exchange group attached to the bead.

In some embodiments, the porous non-polysaccharide solid support is hydrophilic in nature. In other embodiments, the porous non-polysaccharide solid support is hydrophobic in nature.

In various embodiments, the porous non-polysaccharide solid support is a polymeric membrane. In some embodiments, the polymeric membrane comprises a synthetic polymer selected from the group consisting of polyethylene, polyvinylidine fluoride, polyethersulfone and combinations thereof.

In various embodiments, the negatively charged, multivalent ion exchange group is selected from the group consisting of a sulfate group, a phosphate group and a borate group.

In some embodiments, the immunogen is a virus such as, for example, an influenza virus. In other embodiments, the immunogen is a viral surface protein or an immunogenic fragment thereof. In yet other embodiments, an immunogen is a heparin-binding immunogenic protein, including but not limited to, for example, hemagglutinin.

In some embodiments, the solid support comprises a crosslinked coating which renders the chromatography matrix hydrophilic. The crosslinked coatings may include a homo-polymer or a copolymer of one of: hydroxy-propyl acrylate or hydroxyethyl acrylamide or hydroxylpropyl acrylamide or sulfooxyethyl methacrylate or sulfoxyethyl acrylamide or sulfoxypropyl acrylamide or ethylene glycol methacrylate phosphate.

In a particular embodiment, the crosslinked coating includes hydroxypropyl acrylate hydroxyethyl acrylamide and sulfoxyethyl acrylamide.

In other embodiments, the solid support comprises a hydrophobic coating.

Also encompassed by the present invention are methods of making the novel non-polysaccharide chromatography matrices for purification of immunogens as well as methods of using such matrices.

In some embodiments, a method of separating at least one immunogen from one or more contaminants in a sample is provided, where the method comprises: (a) providing a chromatography matrix comprising a porous non-polysaccharide solid support comprising a negatively charged multivalent ion exchange group directly attached to the support; (b) contacting the sample with the matrix, thereby to allow the at least one immunogen to bind to the matrix: and (c) eluting the at least one immunogen from the matrix, thereby to separate the at least one immunogen from the one or more contaminants in the sample.

In some embodiments according to the methods of the present invention, the solid support comprises a polymeric membrane. In various embodiments, the polymeric membrane comprises a synthetic polymer selected from the group consisting of polyethylene, polyvinylidine fluoride, polyethersulfone and combinations thereof.

In some embodiments, the at least one immunogen is a virus such as, for example, an influenza virus, a herpes simplex virus or a human immunodeficiency virus, or a viral surface protein or fragment thereof. In other embodiments, the at least one immunogen is a heparin-binding immunogenic polypeptide such as hemagglutinin.

In some embodiments according to the methods of the present invention, the negatively charged multivalent ion exchange group is selected from the group consisting of a sulfate group, a phosphate group and a borate group.

### DETAILED DESCRIPTION OF THE INVENTION

The present invention provides a novel and improved chromatography matrix for the purification of immunogens including, but not limited to, viruses and viral surface proteins and immunogenic fragments thereof, e.g., influenza virus, human immunodeficiency virus and herpes simplex virus and one or more proteins expressed on surface of such viruses and immunogenic fragments thereof. Also encompassed by the present invention are methods of purifying immunogenic heparin-binding proteins, including but not limited to, hemagglutinin

The matrices according to the present invention are non-polysaccharide and porous and comprise a negatively charged, multivalent ion exchange group directly attached to the matrix. In some embodiments, these matrices are polymeric synthetic membranes having a negatively charged, multivalent ion exchange group attached directly to the membrane.

It has been previously reported that most heparin-binding biomolecules interact with heparin or heparan sulfate, which is a naturally occurring sulfated carbohydrate molecule in living organisms. Consequently, immobilized heparin on chromatography media has been used in the prior art to purify immunogens such as influenza virus. See, e.g., Segura et al., Methods Mol Biol. 434:1-11 (2008).

For example, matrices such as those disclosed in U.S. Publication No. 20070049746, are primarily polysaccharide (e.g., cellulose) bead based matrices having a negatively-charged, multivalent ion exchange group attached to the bead. Further, while International PCT Publication No. WO2008/039136 mentions both polysaccharide and non-polysaccharide bead based matrices having a negatively-charged, multivalent ion exchange group attached to the matrix, the focus of PCT Publication No. WO2008/039136 appears to be primarily polysaccharide matrices (e.g., agarose). Further, the attachment of a negatively-charged, multivalent ion exchange group to a matrix requires an extender in PCT Publication No. WO2008/039136.

Also, International PCT Publication No. WO2008125361 appears to describe cellulose based sulfate membranes as matrices, which is also a polysaccharide based matrix. Lastly, while U.S. Pat. No. 4,721,572, appears to relate to a non-carbohydrate sulfated gel matrix, it describes use of such a matrix for isolating and purifying blood clotting factors.

Contrary to the matrices described in the prior art, the matrices according to the present invention employ non-polysaccharide based matrices, e.g. synthetic polymeric membranes, and non-polysaccharide based chemistries without extenders, for the purification of immunogens. Further, the matrices according to the present invention are more consistent and uniform in their properties. Notably, the matrices according to the present invention comprise a higher impurity clearance capacity and/or higher binding capacity relative to prior art matrices, further as evidenced by the Examples herein.

In some embodiments, the present invention describes a non-polysaccharide matrix in a membrane format to which a negatively-charged, multivalent ion exchange group is attached directly, where the matrix in the membrane format has a higher binding capacity and/or exhibits higher impurity removal capacity relative to polysaccharide matrices and/or non-polysaccharide matrices in bead form, such as those described in the prior art.

In order that the present disclosure may be more readily understood, certain terms are first defined. Additional definitions are set forth throughout the detailed description.

### I. DEFINITIONS

The term “immunogen,” as used herein, refers to a virus, a viral surface protein or fragment thereof, which is capable of eliciting an immune response in a subject. In some embodiments, an immunogen is a virus, e.g., an influenza virus, a herpes simplex virus or a human immunodeficiency virus. In other embodiments, an immunogen is a viral surface protein or a fragment thereof capable of eliciting an immune response. Also encompassed by the term “immunogen” are immunogenic heparin-binding proteins, e.g., hemagglutinin. Further, the term immunogen may include viral vectors which are used to deliver genetic material into cells and are useful in applications such as microbiology and gene therapy. Common examples of such vectors are bacteriophage, adenoassociated virus and retroviruses.

In a particular embodiment, an immunogen is an influenza virus. The influenza virus has a size of about 75-120 nm and it consists of a core of ribonucleic acid (RNA) associated with a nucleoprotein, which is surrounded by a viral envelope containing a lipid bilayer structure. Typically, the inner layer of the viral envelope is composed dominantly of matrix proteins and the outer layer contains most of the host-derived lipid material, e.g., membrane proteins. The influenza virus envelope contains predominantly the membrane proteins neuramidase (NA) and hemagglutinin (HA) in addition to few other proteins including, e.g., the ion channel forming glycoprotein M2. It is contemplated that an ideal vaccine against the influenza virus should contain at least two essential immunogenic surface proteins such as, for example, hemagglutinin and neuramidase. Accordingly, in some embodiments according to the present invention, compositions and methods described herein can be used for purifying one or more viral proteins, e.g., hemagglutinin and/or neuramidase and/or M2, which may be used for preparation of a vaccine against influenza virus.

In some embodiments, viral surface protein or fragments thereof can be obtained by solubilizing viral surface membrane or the surface membrane of a host cell using surfactants, e.g., as described in Internal PCT Publication no. WO2008125360 A1.

The term “chromatography matrix” or “matrix,” as used herein, refers to a media which can be used for the separation of an analyte (e.g., an immunogen of interest) from one or more impurities in a sample. In some embodiments, a chromatography matrix is porous. In some embodiments, the matrix has a pore size ranging from 0.1 to 10 μm. In some embodiments, a chromatography matrix comprises a porous non-polysaccharide solid support to which a negatively charged multivalent ion exchange group is directly attached (e.g., without the need for an extender).

The term “chromatography,” as used herein, refers to any kind of technique which separates an analyte (e.g., an immunogen of interest) from one or more impurities which are present in a sample along with the immunogen using a chromatography matrix encompassed by the present invention.

The term “purification” or “purify,” as used herein, refers to isolation of an immunogen from a feed stream by a chromatography matrix, as described herein. Further, the term “purification” or “purify” also includes recovery or elution of an immunogen (e.g., a virus) from a chromatography matrix, as described herein.

The term “feed stream” refers to a solution containing the immunogen and other impurities from which the immunogen needs to be purified or isolated.

The term “solid support,” as used herein, refers to a non-polysaccharide porous matrix to which a negatively charged multivalent ion exchange group can be attached, without the use of an extender. Exemplary formats for solid support include, but are not limited to, a column, a bead, a membrane, a fiber, a sheet such as a woven fabric, a non-woven, a mat or a felt. In some embodiments, the solid support is in the form of a polymeric membrane. In some embodiments, the solid support has a hydrophilic crosslinked coating. In other embodiments, the solid support is hydrophobic. In general, the terms “base matrix” and “solid support” may be used interchangeably herein. In a particular embodiment, a solid support comprises a membrane format.

The terms “contaminant,” “impurity,” and “debris,” as used interchangeably herein, refer to any foreign or objectionable molecule, including a biological macromolecule such as a DNA, an RNA, one or more host cell proteins, endotoxins, lipids and one or more additives which may be present in a sample containing an immunogen of interest (e.g., a virus or a virus surface protein or a fragment thereof) being separated from one or more of the foreign or objectionable molecules using a chromatography matrix according to the present invention.

In some embodiments, the matrices described herein comprise a higher impurity removal relative, to a polysaccharide matrix containing a negatively charged multivalent ion exchange group. In some embodiments, the matrices according to the claimed invention exhibit impurity removal which is at least 1.2 times higher or 1.5 times higher or 2 times higher or 3 times higher or 4 times higher or 5 times higher or 6 times higher or 7 times higher or 8 times higher or 9 times higher or 10 times higher or 15 times higher or more than 15 times higher relative to the impurity removal exhibited by various commercially available polysaccharide matrices containing a negatively charged multivalent ion exchange group such as, for example Cellufine sulfate. In a particular embodiment, the matrices according to the claimed invention exhibit host cell protein or host cell DNA removal or clearance which is several fold higher than that exhibited by a commercially available polysaccharide matrix, e.g., Cellufine sulfate, as further demonstrated by the examples included herein.

The static binding capacity or dynamic binding capacity of a matrix or media for purifying an immunogen of interest can be readily determined using known techniques in the art. In general, a high capacity of the matrix for an immunogen indicates that the matrix is capable of binding the immunogen. Conversely, a low or negligible capacity for immunogen may indicate that the immunogen is not the entity of interest.

The term “capacity” of a chromatography media, as used herein, refers to the dynamic binding capacity of a media which is the amount of an immunogen (e.g., a virus or virus surface protein or fragment thereof) that is bound per unit volume of the media in a dynamic mode. It may be expressed as follows:

Capacity=(Total amount of virus in feed−Total amount of virus in flow-through)/Volume of media

The dynamic capacity of a chromatography media reflects the impact of mass transfer limitations that may occur as flow rate is increased and it is useful in predicting real process performance compared to a determination of saturated or static binding capacity of the media. The matrices according to the claimed invention typically have a greater dynamic binding capacity than various other commercially available matrices, e.g., the cellufine sulfate media and GE media.

In some embodiments, the binding capacity of a matrix according to the claimed invention for an immunogen (e.g., a virus such as an influenza virus or a immunogenic viral surface protein) is at least 2 times greater than the binding capacity of various commercially available polysaccharide matrices containing a negatively charged multivalent ion exchange group (e.g., a Cellufine sulfate matrix or a Capto Devirus matrix). The binding capacity of a matrix according to the present invention for an immunogen may be at least 2 times or at least 3 times or at least 4 times or at least 5 times or at least 6 times or at least 7 times or at least 8 times or at least 9 times or at least 10 times or at least 11 times or at least 12 times or at least 13 times or at least 14 times or at least 15 times or at least 20 times or more greater than that of one or more of the various commercially available polysaccharide based matrices, as further demonstrated by the Examples included herein.

The term “anion exchange chromatography” or “AEC.” as used herein, refers to a chromatographic process that uses a positive charge to separate an immunogen of interest from one or more contaminants in a sample. Exemplary commercially available AEC matrices include Q SepharoseFF, Q Sepharose XL, Capto Q, Q Sepharose HP, all from GE Healthcare, Fractogel EMD TMAE, Fractogel EMD DEAE from EMD Chemicals Inc. Toyopearl DEAE, Toyopearl QAE and Toyopearl SuperQ from TOSH Bioscience, and Sartobind Q from Sartorius and Mustang Q from Pall Corporation.

The term “cation exchange chromatography” or “CEC,” as used herein, refers to a chromatographic process that uses a negative charge to separate an immunogen of interest from one or more contaminants in a sample. Exemplary commercially available CEC matrices include SP Sepharose, SP Sepharose HP, all from GE Healthcare, Fractogel EMD SO₃⁻ from EMD Chemicals Inc, Toyopearl SP and Toyopearl CM from TOSH Bioscience, Sartobind S from Sartorius, Mustang S from Pall Corporation.

The term “hydrophobic interaction chromatography” or “HIC,” as used herein, refers to a chromatographic process that uses a matrix immobilized with aromatic or aliphatic hydrocarbons as hydrophobic groups to separate an immunogen of interest from one or more contaminants in a sample. Exemplary commercially available HIC matrices include Phenyl Sepharose from GE Healthcare, Fractogel EMD Propyl 650, Fractogel EMD Phenyl 650 from EMD Chemicals Inc, and Toyoperal Phenyl, Toyopearl Butyl, Toyopearl Hexyl, Toyopearl Ether from TOSH Bioscience, and Sartobind HIC membrane adsorber from Sartorius.

The term “size exclusion chromatography” or “SEC,” as used herein, refers to a chromatography process which is based on the principle that, when a solution containing solutes of different sizes is passed through a porous media having an appropriate pore size, the smaller size solutes take a longer time to diffuse out of the media and therefore have a longer retention time, whereas, the larger size solutes diffuse out quickly, thereby allowing their separation from the smaller size solutes. Exemplary commercially available SEC matrices include Toyopearl HW, Sepharose, Sephacryl and Fractogel EMD BioSEC.

The term “affinity chromatography,” as used herein, refers to a mode of chromatography where the analyte to be separated (e.g., an immunogen) is isolated by its interaction with a molecule which specifically interacts with the analyte. The term “pseudo-affinity,” as used herein, refers to the nature of interactions between the binding substrate and the bound molecule which can be construed as a combination of bio-affinity and ionic or hydrophobic behavior.

The term “multivalent negatively charged ion exchange group,” as used herein, refers to negatively charged ions or ligands possessing more than one ionizable group such as, for example, sulfate, phosphate, and borate.

The term “directly attached” or “direct attachment,” as used herein, refers to attachment of ligands (e.g., a multivalent negatively charged ion exchange group) on to a solid support without the need for an extender. Extenders have been described in the art (e.g., see, PCT Publication No. WO98/33572) and are understood to be free floating, thereby making them distinct from linkers. While the present invention obviates the need to use an extender for attaching a ligand onto a solid support, a linker or spacer may be used in the compositions and methods according to the claimed invention. Accordingly, a ligand may be directly attached to the coating on the base matrix or through a linker of up to 2-10 carbon long. In some embodiments, a ligand may be attached to a solid support via a linker, which attaches to a single point on the solid support at one end and contains a desirable functional group which binds to the immunogen of interest at the other end, thereby attaching the immunogen to the solid support.

### II. EXEMPLARY NON-POLYSACCHARIDE SOLID SUPPORTS

The chromatography matrices according to the present invention include a solid support to which a negatively charged multivalent ion exchange group is directly attached, i.e., without the need for an extender.

Many different types of solid supports can be used in the practice of the claimed invention. The solid supports are generally non-polysaccharide in nature and may be present in different formats such as, for example, membranes, beads, fibers, sheets, mats, and woven or non-woven fabrics. In some embodiments according to the present invention, the solid support is a non-polysaccharide membrane (e.g., a synthetic polymeric membrane made from a non-polysaccharide material). In some embodiments, a non-polysaccharide membrane according to the present invention is porous having a pore size ranging from about 0.1 to about 10 μm.

Examples of polysaccharide materials which are generally used for making chromatography matrices include, for example, cellulose, reinforced cellulose, agarose, chitosan, dextran, cellulose nitrate and cellulose acetate.

Examples of non-polysaccharide materials which may be used for the generation of non-polysaccharide solid supports, include, for example, Millipore Durapore (PVDF), Millipore Express Membrane (PES), Millipore Fluropore membrane (PTFE), Millipore Mitex membrane (PTFE), Millipore LCR membrane (PTFE), Millipore Omnipore membrane (PTFE), Millipore Isopore membrane (polycarbonate), Millipore Polyethylene therepethalate membrane, Entagris-Ultra high density polyethylene and polyether sulfone membranes, Pro-Res (Millipore Corporation), Fractogel (Merck), and CPG (Millipore Corporation).

Further, a solid support according to the present invention may be hydrophobic or hydrophilic in nature. In some embodiments, a non-polysaccharide porous solid support (e.g., a polymeric membrane) according to the present invention has a hydrophilic crosslinked coating. Examples of hydrophilic coating materials include, but are not limited to, polyamides and polyacrylates. Also, commercially available surface treated hydrophilic porous membranes include, but are not limited to, Durapore® (Millipore Corporation, Billerica Mass.). In another embodiment, a solid support is a non-polysaccharide polymeric membrane which is hydrophobic. Examples of hydrophobic materials include, but are not limited to, polyolefins, polyvinylidene fluoride, polytetafluoroethylene, polysulfones, polycarbonates, polyesters, polyacrylates, and polymethacrylates.

### III. METHODS OF RENDERING THE SOLID SUPPORT HYDROPHILIC

In various embodiments according to the present invention, a chromatography matrix comprises a solid support which is rendered hydrophilic using processes known in the art and/or those described herein.

In some embodiments, a solid support according to the present invention (e.g., a synthetic polymeric membrane) is rendered hydrophilic by coating the surface of the membrane with a crosslinked hydrophilic non-polysaccharide polymer.

A hydrophilic coating can be formed on the solid support either by adsorbing preformed polymers on to the support and then crosslinking the polymer or by polymerizing monomers along with crosslinking agents on the surface of the solid support. Polymers that can be adsorbed onto the solid supports include, but are not limited to polyvinyl alcohol, polyethylene glycol, polyethylenimine, polyallylamine along with crosslinking agents such as epichlorohydrin, diviylsulfone and butanediol diglycidyl ether. Various monomers that can be used to form polymers on the surface of the membrane may include, but are not limited to, acrylates, acrylamides, vinyl alcohols along with crosslinking agents such as methylenebisacrylamide, divinyl sulfone and di(ethylene glycol) divinyl ether. In one embodiment, a polymeric coating can be directly formed on the surface of the support using a process similar to that described in U.S. Pat. No. 7,073,671, incorporated by reference in its entirety.

### IV. EXEMPLARY NEGATIVELY CHARGED, MULTIVALENT ION EXCHANGE GROUPS AND METHODS OF ATTACHING THE SAME TO THE SOLID SUPPORTS

The chromatography matrices according to the present invention include non-polysaccharide porous solid supports to which a negatively charged multivalent ion exchange group is directly attached. Exemplary negatively charged multivalent ion exchange groups include, but are not limited to, sulfate, phosphate, borate, oxalate, thiosulfate, and nitrate groups.

In some embodiments, a negatively charged, multivalent ion exchange group is directly attached to a non-polysaccharide solid support having a hydrophilic coating, i.e., without the use of an extender. Methods known in the art or those described herein may be used for directly attaching a negatively charged multivalent ion exchange group to the solid support.

In some embodiments, a negatively charged multivalent ion containing monomer is polymerized by itself or with other monomers and crosslinkers to form a crosslinked functional coating directly on the solid support.

In other embodiments, a neutral or functional coating is first polymerized on to the membrane to make it hydrophilic. The coated solid support is either directly chemically modified or is reacted with negatively charged multivalent moieties to form a solid support comprising negatively charged, multivalent ion exchange groups attached directly to the solid support. Further, while a coating (e.g., a hydrophilic coating) is being formed on the surface of a solid support, monomers containing reactive functional groups can be copolymerized with the other monomers in the coating itself. The reactive functional groups in turn can be reacted with negatively charged multivalent ion containing moieties to form a functional solid support.

Linkers can also be immobilized on the surface of the solid support or coating, which in turn can be reacted with moieties containing negatively charged multivalent ion exchange groups to form a functional solid support.

In order to obtain optimum capacity and purification performance for the matrix (e.g., a membrane), the composition of the multivalent ion exchange group on the matrix (e.g., membrane) can be adjusted, e.g., by: (1) varying the ratio of reactive comonomers used during coating; (2) chemically modifying the base matrix to different extents; (3) using capping agents; or (4) copolymerizing different concentrations of multivalent ion containing comonomers to obtain optimum coating.

### Methods for Measuring Ligand Density

Ligand density is an important parameter as it usually determines the amount of binding of a biomolecule of interest (e.g., an immunogen) to the membrane (i.e., referred to as binding capacity) and the subsequent recovery of the bound biomolecule from the membrane. The ligand density of the base matrix can be optimized, thereby to obtain the desired performance for a certain application. The ligand density of multivalent ions on the membrane can be measured by well known techniques such as, for example, acid-base titration and elemental analysis and those well known in the art as well as described herein. The ligand density may be expressed in any one of the following units (which usually depends on the application and the method of detection): wt % of ligand in media, μmol/gm dry weight of media or μmol/ml of wet media.

For example, in some embodiments, the matrices according to the claimed invention comprise a ligand density in the range of 0.5 to 150 μmol/ml. In other embodiments, the matrices comprise a ligand density in the range of 1 to 70 μmol/ml. In yet other embodiments, the matrices comprise a ligand density in the range of 1 to 50 μmol/ml.

In various embodiments, ligand density may be 0.5 μmol/ml, 1 μmol/ml, 2 μmol/ml, 5 μmol/ml, 10 μmol/ml, 15 μmol/ml, 20 μmol/ml, 25 μmol/ml, 30 μmol/ml, 35 μmol/ml, 40 μmol/ml, 45 μmol/ml, 50 μmol/ml, 55 μmol/ml, 60 μmol/ml, 65 μmol/ml, 70 μmol/ml, 75 μmol/ml, 80 μmol/ml, 85 μmol/ml, 90 μmol/ml, 95 μmol/ml, 98 μmol/ml, 100 μmol/ml or greater than 100 μmol/ml.

In some embodiments, a matrix (e.g., in membrane format) according to the claimed invention comprises the sulfur content in wt % of membrane in the range of 0.1 to 10%: at least 0.1%; or at least 0.2%; or at least 0.3%; or at least 0.4%; or at least 0.5%; or at least 0.6%; or at least 0.7%; or at least 0.8%; or at least 0.9%; or at least 1%, or greater than 1%.

### Exemplary Viruses

Chromatography matrices according to the present invention are useful for the purification/isolation/separation of viruses and viral surface proteins and fragments thereof from one or more impurities.

Examples of viruses include, for example, adenoassociated virus, rabies virus, Japanese encephalitis virus, feline leukemia virus, feline herpes virus, feline calicivirus virus, respiratory syncytial virus, influenza virus, human herpes simplex virus, human measles virus, human parainfluenza virus, and human immunodeficiency virus.

### VII. METHODS OF PURIFYING AN IMMUNOGEN USING A CHROMATOGRAPHY MATRIX ACCORDING TO THE INVENTION

The present invention provides improved chromatography matrices and methods for using such matrices to separate immunogens such as, for example, viruses, viral surface proteins, fragments thereof and recombinant biomolecules containing immunogenic proteins, from one or more impurities in a sample containing the immunogen and the one or more impurities. A recombinant biomolecule containing an immunogenic protein may be expressed in a host cell or a genetically engineered cell expressing the recombinant biomolecule (or the immunogenic protein) on the cell surface.

In an exemplary method, the process of separation involves contacting a feed solution containing the immunogen of interest (e.g., a virus such as an influenza virus) and one or more impurities with a chromatography matrix such as those described herein, until the matrix reaches its maximum capacity. The matrix is subsequently washed with a suitable buffer to remove any loosely bound molecules or any non-specifically bound impurities. The matrix is then treated with an elution buffer and elution pools/fractions containing the immunogen of interest are collected. In some embodiments, the matrix is packed inside a device or a column. In some embodiments, such a device or column containing the matrix can capture only the immunogen of interest with minimal to no binding for the impurities resulting in a purer and concentrated product in the elution pool.

In an exemplary experiment described herein, an immunogen, e.g., influenza virus, was grown using a MDCK cell line. The virus-containing feed was preclarified using centrifugation followed by use of a 0.45 μm membrane filtration in order to remove large cell debris. Optionally, other preparative steps such as, for example, centrifugal filtration, depth filtration, tangential flow filtration, dia-filtration and buffer exchange may be used for various feeds containing the virus obtained from different sources (e.g., cell culture, eggs etc.) before purification using the chromatography mode, as described herein.

Following preclarification of a feed containing the immunogen of interest, it is subjected to chromatography matrix directly or buffer exchanged into a suitable buffer using a Centricon (Millipore Corporation) centrifugal filter and then contacted with the matrix. The separation was performed by first equilibrating the chromatography matrix with the equilibration buffer such as phosphate. Then the feed was passed through the matrix followed by washing with wash buffer. The bound virus was eluted using either a single step gradient salt elution or a continuous gradient salt elution of a multiple step gradient salt elution.

In an exemplary setup, a positive displacement pump (e.g., Mighty-Mini, Scientific Systems Inc.) or a peristaltic pump (Watson Marlow 205S) and a device/column are used in series. For example, the pump and the tubing are first sanitized using 20% ethanol or 0.15 to 0.5N NaOH and then flushed with water and buffer. The equilibration buffer, the virus containing feed, wash buffer and elution buffers of interest were subsequently passed through the device/column using the pump and fractions are collected manually at the downstream of the device/column into eppendorf tubes.

In another exemplary setup, a more self contained apparatus such as an Akta (GE Healthcare) or a BioCad (Applied Biosystems) may be used. These systems allow for automated pumping and control of feed and buffers, inline measurement of UV and conductivity signals of streams and automatic fraction collection. The fractions collected from the load, wash and elute steps were further used for offline measurements.

### VIII. METHODS OF MEASURING TITER OF RECOVERED IMMUNOGEN

Following the separation of an immunogen from one or more impurities using a process described herein, the titer of the recovered immunogen can be measured.

Techniques for the detection of various immunogens including viruses are generally well known in the art and have been described in the literature. Tilters of immunogens recovered using chromatography processes may be measured either inline or offline. An inline detection technique involves detectors in series placed downstream of the chromatographic setup. Whereas offline methods of analysis are accomplished by collecting fractions of the solution flowing through the chromatography column and assaying those using standard techniques. Offline detection is generally used if there are interferences from different species in the inline technique, if the immunogen is not detectable using an available inline technique or if concentrations of an immunogen of interest are below the detection limits of the inline technique.

A commonly used inline measurement technique for viruses, proteins and DMA is UV spectroscopy at 280 nm and 260 nm (see, e.g., European patent application no. EP 1801 697 A1). Also, recently multi-angle laser light scattering (MALS) has been successfully used to quantify viruses inline in a chromatographic process (see, e.g., Opitz et al. Biotech. Bioengg., 103:1144-1154 (2009)).

Offline measurement techniques include the above mentioned techniques, such as UV spectroscopy and dynamic light scattering (see, e.g., Opitz et al., J. Biotech., 131:309-317 (2007)) as well as additional techniques that are unique to the immunogen of interest which is being measured. For example, some of the commonly used offline measurement techniques for proteins include, the bicinchoninic acid assay (BCA) (see, e.g., U.S. Publication no. 20050118140), the Bradford assay (see, e.g., Nayak et al. J. Chrom., 823:75-81 (2005)) and the Enzyme-Linked Immunosorbent Assay (ELISA) (see, e.g., U.S. Publication no. 20050118140).

Most viruses can be detected and quantified using a tissue culture infectious dose assay (also referred to as TCID50 plaque assay) (see, e.g., Dulbecco et al., Cold Spring Harbor Symp. Quant. Biol., 18:273-279 (1953)). However, unique assays are generally used to identify and quantify particular viruses, e.g., the influenza virus is quantified using assays such as hemagglutination (HA), neuraminidase (NA) and single radial immunodiffusion (SRID) assays (see, e.g., Methods in Molecular Biology 436, Avian Influenza Virus, edited by Spackman, E. Humana Press (2007)). The results of hemagglutination assay are expressed in hemagglutination units (HAU)

This invention is further illustrated by the following examples which should not be construed as limiting. The contents of all references, patents and published patent applications cited throughout this application, as well as the FIGURES, are incorporated herein by reference.

### EXAMPLES

### Example 1

### Synthesis of a Sulfated Non-Polysaccharide Membrane (S1) by Direct Surface Modification of Coating

In a representative experiment, ultra high density polyethylene (UPE, Entegris, Inc.) with an average pore size of 1 μm was used as the solid support. A monomer mixture consisting of 1-hydroxypropyl acrylate and 2-hydroxypropyl acrylate (HPA) and crosslinker N—N′ Methylenebisacrylamide (MBAM) obtained from Sigma Aldrich Corporation was used to coat the membrane using Irgacure 2959 (Ciba, now part of BSAF) as the photoinitator, thereby to render the membrane hydrophilic. Water (DI) used for polymerization was purified using a Milli-Q system (Millipore Corporation) whereas acetone was obtained from Fisher Scientific and used as is. Further, sulfation was achieved through reaction with chlorosulfonic acid (Sigma Aldrich) using dichloromethane (Sigma Aldrich) as solvent.

A solution photo-polymerization technique was used to coat the UPE membrane with HPA. A monomer solution containing 6% HPA, 0.9% MBAM, 0.2% Irgacure 2959, 5% acetone and 87.9% water by weight was prepared. The membrane was prepared by pre-wetting it in isopropyl alcohol (IPA) followed by water exchange and then immersed in the monomer solution for a few minutes. The excess solution in the membrane was removed and the membrane was irradiated using a UV curing system (120 W/cm, Fusion System Corporation) at a speed of 25 feet/min to initiate the polymerization of HPA and form a coating on the surface of the membrane. The membrane was thoroughly washed and extracted in DI water overnight, and then dried at room temperature overnight. The surface modification of the membrane was confirmed using infrared spectroscopy.

In order to directly attach sulfate groups to the HPA coated UPE membranes, the membrane and a 15% solution of chlorosulfonic acid in dichloromethane by volume were pre-cooled for 20 min in an ice bath in separate containers. The chlorosulfonic acid solution was added to the membrane container, which was then rotated in the hybridizer for 25 min with the ice bath jacket around it. The membrane container was then removed from the jacketed ice bath and rotated in the hybridizer for 1 hr at room temperature. At the end of the reaction the membranes were washed three times with acetone and water and then dried at room temperature. Direct attachment of sulfate groups to the membrane was confirmed using FTIR spectroscopy and elemental analysis.

### Example 2

### Synthesis of a Sulfated Non-Polysaccharide Membrane (S2) by Direct Surface Modification of Coating Using a Linker

In another representative experiment, the base UPE membrane (1 μm, Entegris, Inc.) was coated with glycidyl methacrylate (GMA, Sigma Aldrich Corporation) using N—N′ Methylenebisacrylamide (MBAM, Sigma Aldrich Corporation) as the crosslinker and Irgacure 2959 (Ciba, now part of BSAF) as the photoinitator. Water (DI) used for polymerization was purified using a Milli-Q system (Millipore Corporation) whereas acetone was obtained from Fisher Scientific and used as it is. Further, functionalization was achieved through grafting of 2-aminoethyl hydrogen sulfate (AES, Sigma Aldrich) in a solution of dimethylsulfoxide (DMSO, Sigma Aldrich) containing triethylamine (TEA, Fisher Scientific).

Similar to Example 1, solution photo-polymerization technique was used to coat the UPE membrane with glycidyl methacrylate. A precursor solution containing, 2% GMA, 3% MBAM, 0.2% Irgacure 2959, 6% acetone and 88.8% water by weight was prepared. The membrane prepared as described in Example 1 were immersed in the precursor solution. The excess solution on the membrane was removed and the membrane was irradiated using a UV system (120 W/cm, Fusion System Corporation) at a speed of 10 feet/min to initiate polymerization of GMA and form a coating directly on the surface of the membrane. The membranes were then thoroughly washed and extracted in DI water overnight and then dried at room temperature overnight.

In order to directly attach sulfate groups onto the membrane, the coated membrane was immersed in a 25% (w/v) solution of AES in DMSO, preheated to 70° C. TEA (1 molar equi. to AES) was added to the solution mixture and the reaction was allowed to proceed overnight at 70° C. in the hybridizer. Following the reaction, the membranes were thoroughly washed with water and dried overnight at room temperature. Direct attachment of sulfate groups to the membrane was confirmed using FTIR spectroscopy and elemental analysis.

### Example 3

### Synthesis of a Sulfated Membrane by Directly Forming a Sulfated Non-Polysaccharide Coating

In an exemplary example, ultra high density polyethylene (UPE, Entegris, Inc.) with an average pore size of 1 μm is coated with a crosslinked coating according to method described by Pitt et. al. (U.S. Pat. No. 5,037,656). A mixture of monomers such as hydroxypropyl acrylate (HPA) and 2-(Sulfooxy)ethyl methacrylate ammonium salt (Sigma Aldrich) and crosslinker N-N-methylenebisacrylamide is UV polymerized (120 W/cm, Fusion System Corporation) using Irgacure 2959 (Ciba, now part of BSAF) as an initiator to directly form a crosslinked charged coating containing multivalent sulfate ions on the surface of the membrane. The coated membrane so obtained is then washed several times with DI water to remove any un-reacted monomers.

### Example 4

### Purification of Influenza Virus-Type A Using Non-Polysaccharide Sulfate Membranes S1 and S2

In this representative experiment, the purification of influenza virus-type A (Flu-A), from a mixture of host cell protein (HCP) and host cell DNA is described. Influenza-type A is a lipid enveloped virus with a pl of ˜5.0 and a size of approximately 80 to 120 nm. It has an overall negative charge above pH 5. The study was performed in bind-wash-elute mode using clarified and buffer exchanged flu feed prepared in-house.

Feed containing influenza type A virus grown in MDCK cells was prepared using standard procedure. Initially, fifty T150 flasks were seeded at 10% confluency MDCK cells in 10% FBS DMEM. After 2-3 days, or once the cells were 80-90% confluent, the media in the flasks was changed to DMEM without serum and the cells were infected with influenza type A/Wisconsin (H1N1 strain) which was tissue culture adapted to growth in MDCK cells. The flasks were then incubated at 33° C. in 5% CO₂ for 3 days until complete CPE (Cytopathic effect) was observed. The culture was subsequently centrifuged at 2500 RPM, and the supernatant was filtered through a 0.45 μm membrane filter (Millipore Corporation) to remove cell debris and stored at −80° C. before further use.

Just prior to the experiment, desire amount of supernatant was thawed at 4° C. overnight and then buffer exchanged into 10 mM phosphate buffer at pH 7.4 using a 10 Kilo-Dalton Centricon centrifugal filter device (Millipore Corporation). This was used as feed for further chromatography experiments.

In order to study influenza virus separation, three devices each of S1 and S2 membranes (consisting of 8 layers each, 0.08 ml) and three pre-packed columns (1 ml each) containing Cellufine Sulfate resin (Chisso Corporation) were equilibrated with 10 mM phosphate buffer at pH 7.4. The feed was passed through each device and column separately at a flow rate of 0.5 ml/min using an Akta explorer 100 or a positive displacement pump (Watson Marlow). The devices and columns were then washed with the equilibration buffer and the molecules bound to the membranes were eluted using 10 mM phosphate buffer at pH 7.4 containing 1.6M NaCl. The flow through, wash and elute from each device/column was collected separately and assayed in duplicate for influenza virus, host cell DNA and total protein content, using hemagglutinin (HA), pico-green and bicinchoninic acid (BCA) assay respectively.

Table 1 summarizes the average influenza virus type A/Wisconsin capacity, average total virus recovered in product per ml of media and the average percentage of the feed DNA and total protein found in the final product for the membranes synthesized in example 1 & 2 (S1 & S2), cellufine sulfate and compares it with literature data for sulfated cellulose membrane adsorber, all of which were studied at 0.5 ml/min flow rate.

TABLE I

| | Product Bound | | Product Eluted | | | | |
|---|---|---|---|---|---|---|---|
| | Capacity of | | | | ^{⊙}Protein | % of feed | ^{∉}DNA |
| | Influenza | ^{#}Capacity | Total virus | % of feed | clearance | double | clearance |
| | A/Wisconsin | relative to | recovered/ | protein | relative to | stranded | relative to |
| Media | (HAU/ml | Cellufine | ml of media | found in | Cellufine | DNA found | Cellufine |
| Type | media) × 10⁵ | sulfate | (HAU/ml) × 10⁵ | product | Sulfate | in product | Sulfate |
| Cellufine | 1.35 | NA | 1.1 | 18 | NA | 3.5 | NA |
| Sulfate | | | | | | | |
| S1 | 16 | 11.8 | 1.1 | 4.6 | 3.9 | 2.5 | 1.6 |
| (Example 1) | | | | | | | |
| S2 | 16 | 11.8 | 8.9 | 3 | 6 | 1.5 | 2.3 |
| (Example 2) | | | | | | | |

Literature*

| | | | | | | | |
|---|---|---|---|---|---|---|---|
| Cellufine | — | NA | — | 62.7 | NA | 8.9 | NA |
| Sulfate | | | | | | | |
| Sulfated | — | ~1.3 | — | 42.9 | 1.4 | 31.9 | 0.27 |
| cellulose | | | | | | | |
| membrane | | | | | | | |
| adsorber | | | | | | | |

NA—Not applicable
*Data referenced or calculated from WO2008125361
^{#}Capacity relative to Cellufine Sulfate = Capacity of membrane/capacity of Cellufine sulfate
^{⊙}Protein Clearance relative to Cellufine sulfate = % of feed protein found in product for Cellufine Sulfate/% of feed protein found in product for membrane
^{∉}DNA Clearance relative to Cellufine sulfate = % of feed double stranded DNA found in product for Cellufine Sulfate/% of feed double stranded DNA found in product for membrane

As demonstrated in Table 1, influenza virus binds to the non-polysaccharide sulfated membranes S1 and S2. The membranes showed significantly greater capacity for virus than cellufine sulfate and the sulfated cellulose membrane adsorber. The virus can also be eluted from these membranes using salt. While high salt concentration was used to elute the virus in these experiments, it was observed that virus could be eluted from the membranes at much lower salt concentrations (not shown here). Further, very good removal of impurities such as DNA and HCP could also be achieved using the non-polysaccharide sulfated membranes S1 and S2. This allows for virus product of higher purity to be obtained with the use of S1 & S2 than with the use of cellufine sulfate resin or sulfated cellulose membrane adsorber. Based on the above observations it can be concluded that the membranes according to the present invention exhibit superior performance for virus purification.

### Example 5

### Purification of Crude Influenza Virus-Type A Using Non-Polysaccharide Sulfate Membranes S1 and S2

This representative experiment, describes the purification of crude influenza virus-type A (Flu-A), from a mixture of host cell protein (HCP), host cell DNA and other cell culture additives. The chromatographic separation of influenza virus Wisconsin/A was studied in bind/elute mode using clarified cell culture supernatant prepared in-house as feed.

Feed containing influenza virus Wisconsin/A virus grown in MDCK cells in a manner similar to that described in example 4. The cell culture supernatant was subsequently centrifuged at 2500 RPM, and the supernatant was filtered through a 0.45 μm membrane filter (Millipore Corporation) to remove cell debris and stored at −80° C. before further use. Prior to the experiment, desired amount of this supernatant was thawed at 4° C. overnight and directly used as feed for further chromatography experiments.

The chromatography experiment was performed in a manner similar to that described in Example 4. Two devices (0.08 ml each) of S1 membrane & one device (0.08 ml) of S2 membrane and two pre-packed columns (1 ml) of Cellufine sulfate were studied in parallel using a peristaltic pump. Crude virus feed was first loaded onto the media. The media were then washed with 10 mM phosphate buffer followed by a two step elution consisting of 10 mM phosphate buffer containing 1M NaCl salt and then 2 M NaCl salt. More then 98% of the virus eluted was obtained from the 1M NaCl elution. The output of the experiment was analyzed using hemagglutinin (HA), pico-green and bicinchoninic acid (BCA) assay to determine virus titer, host cell double stranded DNA concentration and total protein content respectively.

Table 2 summarizes the average influenza virus type A/Wisconsin capacity, average total virus recovered in product per ml of media and the average percentage of the feed DNA and total protein found in the final product for the membranes synthesized in example 1 & 2 (S1 & S2), cellufine sulfate and compares it with literature data for sulfated cellulose membrane adsorber, all of which were studied at 0.5 ml/min flow rate.

TABLE 2

| | Product Bound | | Product Eluted | | | | |
|---|---|---|---|---|---|---|---|
| | Capacity of | | | | ^{⊙}Protein | % of feed | ^{∉}DNA |
| | Influenza | ^{#}Capacity | Total virus | % of feed | clearance | double | clearance |
| | A/Wisconsin | relative to | recovered/ | protein | relative to | stranded | relative to |
| Media | (HAU/ml | Cellufine | ml of media | found in | Cellufine | DNA found | Cellufine |
| Type | media) × 10⁵ | sulfate | (HAU/ml) × 10⁵ | product | Sulfate | in product | Sulfate |
| Cellufine | 2.5 | NA | 3 | 14 | NA | 10.6 | NA |
| Sulfate | | | | | | | |
| S1 | 16 | 6.4 | 11 | 3 | 4.6 | 7.3 | 1.45 |
| (Example - 1) | | | | | | | |
| S2 | 30 | 12 | 11 | 2 | 7 | 7.3 | 1.45 |
| (Example- 2) | | | | | | | |

Literature*

| | | | | | | | |
|---|---|---|---|---|---|---|---|
| Cellufine | — | NA | — | 62.7 | NA | 8.9 | NA |
| Sulfate | | | | | | | |
| Sulfated | — | ~1.3 | — | 42.0 | 1.4 | 31.9 | 0.27 |
| cellulose | | | | | | | |
| membrane | | | | | | | |
| adsorber | | | | | | | |

NA—Not applicable
*Data referenced or calculated from W02008125361
^{#}Capacity relative to Cellufine Sulfate = Capacity of membrane/capacity of Cellufine sulfate
^{⊙}Protein Clearance relative to Cellufine sulfate = % of feed protein found in product for Cellufine Sulfate/% of feed protein found in product for membrane
^{∉}DNA Clearance relative to Cellufine sulfate = % of feed double stranded DNA found in product for Cellufine Sulfate/% of feed double stranded DNA found in product for membrane

The results of Example 5 as seen in Table 2, are in line with that observed in Example 4. The non-polysaccharide sulfated membranes S1 and S2 selectively bind to the virus even in a highly impure feed stream. The membranes showed significantly greater capacity and higher impurity removal (DNA and total protein) than cellufine sulfate and the sulfated cellulose membrane adsorber. The virus could also be eluted from these membranes using 1M salt. This experiment demonstrates that influenza virus could be purified even from crude highly impure feed using the non-polysaccharide membranes described herein.

### Example 6

### Purification of Influenza Virus-Type B Using Non-Polysaccharide Sulfate Membranes S1 and S2

This representative example, describes the purification of influenza virus-type B (Flu-B), from a mixture of host cell protein (HCP) and host cell DNA. The chromatographic separation of influenza Lee/B virus was studied in bind/elute mode using clarified and buffer exchanged flu feed prepared in-house.

Feed containing human influenza virus type B/Lee was grown using standard mammalian cell culture technique in MDCK cells. Initially, eight T150 flasks were seeded with about 2.0×10⁷ cells/flask in 10% FBS DMEM. After 24 hrs. the media in the flasks was changed to 1% FBS in DMEM and the cells were infected with influenza virus type B strain B/Lee/40 (ATCC #VR-1535) which was tissue culture adapted to growth in MDCK cells. The flasks were then incubated at 37° C. in 5% CO₂ for 5 days until complete CPE (cytopathic effect) was observed. The culture was subsequently centrifuged at 2500 RPM and the supernatant was filtered through a 0.45 μm membrane filter (Millipore Corporation) to remove cell debris and stored at 4° C. before further use. Prior to the experiment, desired amount of this supernatant was thawed at 4° C. overnight and directly used as feed for further chromatography experiments.

The chromatography experiments were performed on an Akata Explorer-10 in a manner similar to that described in Example 4. Two devices of S1 & S2 membrane and two pre-packed columns (1 ml) of Cellufine sulfate resin were tested in parallel. The flow through, bind and elute fractions were assayed for virus and total protein using hemagglutinin (HA) and bicinchoninic acid (BCA) assay respectively.

Table 3 summarizes the average influenza virus type B/Lee capacity, average total virus recovered in product per ml of media and the average percentage of the feed protein found in the final product for the membranes synthesized in example 1 & 2 (S1 & S2) and cellufine sulfate, all of which were studied at 0.5 ml/min flow rate.

TABLE 3

| | Product Bound | | | | |
|---|---|---|---|---|---|
| | Capacity | | | | |
| | of | | Product Eluted | | |
| | Influenza | | Total virus | % of | ^{⊙}Protein |
| | B/Lee | ^{#}Capacity | recovered/ | feed | clearance |
| | (HAU/ml | relative to | ml of media | protein | relative to |
| | media) | Cellufine | (HAU/ml) | found in | Cellufine |
| Media Type | × 10⁴ | sulfate | × 10⁴ | product | Sulfate |
| Cellufine | 3.6 | 1 | 3.3 | 24.5 | 1 |
| Sulfate | | | | | |
| S1 | 46.4 | 12.8 | 26.5 | 4.5 | 5.4 |
| (Example 1) | | | | | |
| S2 | 26.4 | 7.3 | 15.2 | 1.5 | 16.3 |
| (Example 2) | | | | | |

NA—Not applicable
^{#}Capacity relative to Cellufinc Sulfate = Capacity of membrane/capacity of Cellufine sulfate
^{⊙}Protein Clearance relative to Cellufine sulfate = % of feed protein found in product for Cellufine Sulfate/% of feed protein found in product for membrane

The experiment demonstrates that sulfated non-polysaccharide membranes can bind to influenza virus B/Lee strain. Binding of these membranes to influenza A as well as influenza B suggests that the affinity of these membranes is not strain specific. Hence they may be used to purify a wide variety of viruses. Table 3 shows that these membrane have greater capacity for influenza B/Lee virus and higher impurity removal (total protein) than cellufine sulfate. Although the DNA content of the product was not measured in this experiment, based on the similarities in the behavior of the membranes for both influenza A and B it can be expected that the membranes also have good DNA clearance. This experiment demonstrates the non-polysaccharide membranes developed herein can be used to purify a wide variety of strains of the influenza virus.

### Example 7

### Comparison of Non-Polysaccharide Sulfate Membranes S1 and S2 to Resins with Sulfated Extenders

In this representative example, the influenza virus A/Texas/H3N2 capacity of non-polysaccharide membranes S1 & S2 with sulfate groups directly attached to the surface and Capto DeVirs resin (GE health care) with sulfate groups attached through extender groups (Dextran sulfate) was studied. For this influenza virus A/Texas/H3N2 grown in eggs was obtained from Microix Biosystems Inc. The allontoic fluid so obtained was clarified using depth filters (Millipore Corporation) and then buffer exchanged into 10 mM phosphate buffer by diafiltration using a tangential flow filtration system (Millipore Corporation). This was used as feed for chromatography experiments to determine capacity of the membrane and resin for the virus.

Two devices of S1 and S2 membrane each (0.08 ml) and two columns (1 ml) of Capto Devirs resin were tested. The resin was packed in-house into glass columns (Omnifit Corp.) and qualified for HETP and asymmetry using acetone pulse method. Capacity experiments were performed using a peristaltic pump where the devices and column were run in parallel using a procedure similar to that described in Example 4.

Table 4 summarizes the average influenza virus type A/Texas/H3N2 capacity for the membranes synthesized in example 1 & 2 (S1 & S2) and Capto DeVirs resin, all of which were studied at 0.5 ml/min flow rate.

TABLE 4

| | Product Bound | |
|---|---|---|
| | Capacity of Influenza A/Texas | ^{#}Capacity relative to |
| Media Type | (HAU/ml media) × 10⁴ | Capto DeVirs |
| Capto Devirs | 8.8 | 1 |
| S1 (Example 1) | 98. 9 | 11 .2 |
| S2 (Example 2) | 82.3 | 9.3 |

^{#}Capacity relative to Capto Devirs = Capacity of membrane/capacity of Capto Devirs

In the prior art, ligands immobilized using extender groups were considered to offer better capacity for biomolecules than ligands functionalized through direct attachment. However. Table 4 shows the influenza virus capacity of the non-polysaccharide S1 and S2 membranes with sulfate ligands directly attached to the surface is an order of magnitude greater than that of Capto DeVirs resin which has sulfate ligands attached through extenders. From the results of the experiment, it may be concluded that sulfated non-polysaccharide membranes described herein can allow for greater throughput and productivity in a virus purification process as compared to resins with extenders.

### Example 8

### Comparison of Non-Polysaccharide Sulfate Membrane S1 to Sulfated Silica Resin and Sulfated Trisacryl Resins

As demonstrated by Examples 4, 5, 6 and 7, a non-polysaccharide sulfate membrane according to the present invention comprises a higher binding capacity and/or exhibits higher impurity removal relative to a polysaccharide based matrix (e.g., membrane or bead). This Example demonstrates that the membranes according to the claimed invention comprise a higher binding capacity and/or higher impurity removal even relative to a non-polysaccharide sulfated bead.

The representative experiment described herein describes the purification of crude influenza virus-type A (Flu-A), from a mixture of host cell protein (HCP), host cell DNA using non-polysaccharide membrane S1 from example 1 and non-polysaccharide resins described in U.S. Pat. No. 4,721,572, incorporated by reference herein in its entirety.

The chromatographic separation of influenza virus Wisconsin/A was studied in bind/elute mode using clarified cell culture supernatant prepared as feed.

Nugel Polyhydroxy (NPHX) which is a silica based resin coated with a polymer containing hydroxyl groups (bead size—50 μm) was purchased from Biotech Support Group. Tris Acryl GF2000 LS (Pall Corporation) which is a polymeric resin (bead size—80-160 μm) containing hydroxyl groups was obtained from VWR International LLC. Sulfate ligands were attached to both these non-polysaccharide based resins according to procedures decried in U.S. Pat. No. 4,721,572 (Purification of blood clotting factors and other blood proteins using non-carbohydrate sulfated matrices). Briefly, dried resins were separately added to a solution of chlorosulfonic acid in pyridine at 70° C. The mixture was then kept at 50-70° C. for 16 hrs and then filtered to separate the wet cake from the rest of the solution. The wet cake was washed with 1 to 2 M NaCl solution followed by DI water to obtain the pure functionalized sulfated gel. The attachment of the ligand to the resins was confirmed by FTIR spectroscopy and elemental analysis. In the following text the modified resins are referred to as Nugel-Sulfate and Trisacryl-Sulfate.

Feed containing influenza virus Wisconsin/A virus grown in MDCK cells in a manner similar to that described in Example 4. The cell culture supernatant was subsequently centrifuged at 2500 RPM, and the supernatant was filtered through a 0.45 μm membrane filter (Millipore Corporation) to remove cell debris and stored at −80° C. before further use. Just prior to the experiment, desired amount of supernatant was thawed at 4° C. overnight and then buffer exchanged into 10 mM phosphate buffer at pH 7.4 using a 10 Kilo-Dalton Centricon centrifugal filter device (Millipore Corporation). This was used as feed for further chromatography experiments.

The chromatography experiment was performed in a manner similar to that described in Example 4. Two devices (0.08 ml each) of S1 membrane, two columns of Nugel-Sulfate (1 ml), two columns of Trisacryl-Sulfate and one column of Cellufine Sulfate (used as control) were studied in parallel using a multi-channel peristaltic pump (Watson Marlow). To ensure the quality of column packing all columns were qualified for height equivalent number of plates (HETP) and asymmetry prior to the study. The buffer exchanged feed was first loaded onto the media. The media were then washed with 10 mM phosphate buffer followed by a single step elution consisting of 10 mM phosphate buffer containing 1M NaCl salt. The output of the experiment was analyzed using hemagglutinin (HA), pico-green and bicinchoninic acid (BCA) assay to determine virus titer, host cell double stranded DNA concentration and total protein content respectively.

Table 5.1 summarizes the average and relative influenza virus capacity (type A/Wisconsin) for the membranes synthesized in example 1 (S1), Nugel-Sulfate, Trisacryl-Sulfate and Cellufine sulfate all of which were studied at 0.5 ml/min flow rate.

Table 5.2, summarizes the average total influenza virus (type A/Wisconsin) recovered in product per ml of media, % virus recovery and the average percentage of the feed DNA and total protein found in the final product for the membranes synthesized in example 1 (S1). Nugel-Sulfate, Trisacryl-Sulfate and Cellufine sulfate all of which were studied at 0.5 ml/min flow rate.

TABLE 5.1

| | Product Bound | |
|---|---|---|
| | Capacity of Influenza | |
| | A/Wisconsin | ^{#}Capacity relative to |
| Media Type | (HAU/ml media) × 10⁵ | Cellufine sulfate |
| S1 Membrane | 19 | 16 |
| Nugel-Sulfate | 1.1 | 0.9 |
| Trisacryl-Sulfate | 0.43 | 0.36 |
| Cellufine Sulfate | 1.2 | 1 |

TABLE 5.2

| | Product Eluted | | | | | |
|---|---|---|---|---|---|---|
| | | | | ^{⊙}Protein | % of feed | ^{∉}DNA |
| | Total virus | | % of feed | clearance | double | clearance |
| | recovered/ | | protein | relative to | stranded | relative to |
| Media | ml of media | ^{Φ}% Virus | found in | Cellufine | DNA found | Cellufine |
| Type | (HAU/ml) × 10⁵ | recovery | product | Sulfate | in product | Sulfate |
| S1 | 17 | 90 | 13 | 2.7 | 14 | 1.14 |
| Membrane | | | | | | |
| Nugel- | 0.66 | 63 | 12 | 3 | 17 | 0.94 |
| Sulfate | | | | | | |
| Trisacryl- | 0.25 | 30 | 21 | 1.7 | 11 | 1.45 |
| Sulfate | | | | | | |
| Cellufine | 0.8 | 70 | 36 | 1 | 16 | 1 |
| Sulfate | | | | | | |

^{#}Capacity relative to Cellufine Sulfate = Capacity of membrane or resin/ capacity of Cellufine Sulfate
^{⊙}Protein Clearance relative to Cellufine sulfate = % of feed protein found in product for Cellufine Sulfate/% of feed protein found in product for membrane or resin
^{∉}DNA Clearance relative to Cellufine sulfate = % of feed double stranded DNA found in product for Cellufine Sulfate/% of feed double stranded DNA found in product for membrane or resin
^{Φ}% Virus recovery = Virus found in eluted product/Virus bound to membrane or resin.

Table 5 shows that the non-polysaccharide membrane S1 has virus binding capacity several times higher than the non-polysaccharide resins Nugel-Sulfate, Trisacryl-Sulfate and the polysaccharide resin cellufine sulfate. The HCP and DNA removal of the non-polysaccharide membrane is either higher or comparable to other non-polysaccharide resins and higher than that of Cellufine sulfate. The virus could be eluted from the membrane and the resin using 1M salt. However the total virus recovered from the membrane was an order of magnitude greater than that from the resins. Also the % virus recovery from the membrane was much higher than the resins. From the above results it can be concluded that the non-polysaccharide sulfated membranes developed in this invention out performs both polysaccharide and non-polysaccharide sulfated resins.

### Example 9

### Measuring Ligand Density of Non-Polysaccharide Sulfated Membranes

Ligand density of the membranes was determined by measuring weight % of sulfur in the dry membrane. The weight % of sulfur in the dry membrane was determined by elemental analysis using Induction couple plasma analysis, the results of which are shown in Table 6

Table 6 summarizes the average wt % of sulfur in the non-polysaccharide membranes developed in example 1 & 2 (S1 & S2), cellufine sulfate and Capto DeVirs. The data also shows literature values for cellufine sulfate and the sulfated membrane adsorber.

TABLE 6

| Media | Wt. % Sulfur |
|---|---|
| S1 (Example 1) | 0.68 |
| S2 (Example 2) | 0.54 |
| Cellufine Sulfate | 0.085 |
| Capto DeVirs | 1.92 |
| Nugel-Sulfate | 0.056 |
| Trisacryl-Sulfate | 8.97 |

Literature

| | |
|---|---|
| ^{Φ}Cellufine Sulfate | 0.07-0.16 |
| ^{Y}Sulfated cellulose | 0.5-15 (claimed) |
| membrane adsorber | |

^{Y}Data referenced from WO2008125361 A1
^{Φ}Data referenced from US20070049746 A1 and Cellufine sulfate data sheet

It can be noted from Table 6 that the sulfur content of the polysaccharide resin and membrane formats spans over a wide range which extends beyond that of the non-polysaccharide membranes S1 and S2. Similarly the sulfur content of the non-polysaccharide resins also spans over a wide range which extends below and beyond that of the non-polysaccharide sulfated membranes S1 and S2. In spite of this, both the polysaccharide resin/membrane and the non-polysaccharide resins showed no change in virus capacity or impurity clearance with change in ligand density, as seen in Examples 4 to 8. Even the use of sulfated dextran extenders in Capto DeVirs resin does not improve the performance of the polysaccharide media. On the other hand it is interesting to note that non-polysaccharide membranes S1 & S2 showed significantly higher capacity and impurity clearance even with low sulfur content. This finding suggests that the non-polysaccharide membranes described herein are superior for virus purification relative to the polysaccharide matrices described in the art.

The specification is most thoroughly understood in light of the teachings of the references cited within the specification which are hereby incorporated by reference. The embodiments within the specification provide an illustration of embodiments in this invention and should not be construed to limit its scope. The skilled artisan readily recognizes that many other embodiments are encompassed by this invention. All publications and inventions are incorporated by reference in their entirety. To the extent that the material incorporated by reference contradicts or is inconsistent with the present specification, the present specification will supercede any such material. The citation of any references herein is not an admission that such references are prior art to the present invention.

Unless otherwise indicated, all numbers expressing quantities of ingredients, cell culture, treatment conditions, and so forth used in the specification, including claims, are to be understood as being modified in all instances by the term “about.” Accordingly, unless otherwise indicated to the contrary, the numerical parameters are approximations and may vary depending upon the desired properties sought to be obtained by the present invention. Unless otherwise indicated, the term “at least” preceding a series of elements is to be understood to refer to every element in the series. Those skilled in the art will recognize, or be able to ascertain using no more than routine experimentation, many equivalents to the specific embodiments of the invention described herein. Such equivalents are intended to be encompassed by the following claims.

Many modifications and variations of this invention can be made without departing from its spirit and scope, as will be apparent to those skilled in the art. The specific embodiments described herein are offered by way of example only and are not meant to be limiting in any way. It is intended that the specification and examples be considered as exemplary only, with a true scope and spirit of the invention being indicated by the following claims.

What is claimed is:

1. A chromatography matrix for purification of an immunogen, wherein the matrix comprises a non-polysaccharide porous membrane comprising a negatively charged, multivalent ion exchange group directly attached to the membrane at a density of at least 0.1% weight of the membrane.

2. The matrix of claim 1, wherein the matrix comprises a higher binding capacity relative to a polysaccharide matrix comprising a multivalent ion exchange group attached to the matrix.

3. The matrix of claim 1, wherein the matrix comprises a higher binding capacity relative to a non-polysaccharide bead comprising a multivalent ion exchange group attached to the bead.

4. The matrix of claim 1, wherein the matrix comprises higher impurity removal capacity relative to a polysaccharide matrix comprising a multivalent ion exchange group attached to the matrix.

5. The matrix of claim 1, wherein the matrix comprises higher impurity removal capacity relative to a non-polysaccharide bead comprising a multivalent ion exchange group attached to the bead.

6. The matrix of claim 1, wherein the matrix comprises both a higher binding capacity and a higher impurity removal capacity relative to a polysaccharide matrix comprising a multivalent ion exchange group attached to the matrix.

7. The matrix of claim 1, wherein the matrix comprises both a higher binding capacity and a higher impurity removal capacity relative to a non-polysaccharide bead comprising a multivalent ion exchange group attached to the bead.

8. The matrix of claim 1, wherein the negatively charged, multivalent ion exchange group is selected from the group consisting of a sulfate group, a phosphate group and a borate group.

9. The matrix of claim 1, wherein the immunogen is selected from the group consisting of a virus, a viral surface protein or an immunogenic fragment thereof and a recombinant biomolecule comprising an immunogenic protein.

10. The matrix of claim 9, wherein the virus is selected from the group consisting of influenza virus, herpes simplex virus and human immunodeficiency virus.

11. The matrix of claim 9, wherein the viral surface protein is hemagglutinin or neuramidase.

12. The matrix of claim 1, wherein the matrix is hydrophilic.

13. The matrix of claim 12, wherein the matrix is rendered hydrophilic using a crosslinked coating.

14. The matrix of claim 1, wherein the matrix is hydrophobic.

15. The matrix of claim 14, wherein the crosslinked coating comprises a homo-polymer or copolymer of one of hydroxypropyl acrylate or hydroxyethyl acrylamide or hydroxylpropyl acrylamide or sulfooxyethyl methacrylate or sulfoxyethyl acrylamide or sulfoxypropyl acrylamide or ethylene glycol methacrylate phosphate.

16. The matrix of claim 1, wherein the porous membrane is a polymeric membrane.

17. The matrix of claim 16, wherein the polymeric membrane comprises a synthetic polymer selected from the group consisting of polyethylene, polyvinylidine fluoride, polyethersulfone and combinations thereof.

18. The matrix of claim 1, wherein the porous membrane comprises a pore size ranging from 0.1 to 10 microns.

19. A method of separating at least one immunogen from one or more contaminants in a sample, the method comprising:
(a) providing a chromatography matrix comprising a non-polysaccharide porous solid support comprising a negatively charged multivalent ion exchange group directly attached to the support;
(b) contacting the sample with the matrix, thereby to allow the at least one immunogen to bind to the matrix; and
(c) eluting the at least one immunogen from the matrix, thereby to separate the at least one immunogen from the one or more contaminants in the sample.

20. The method of claim 19, wherein the solid support is hydrophilic.

21. The method of claim 19, wherein the solid support is hydrophobic.

22. The method of claim 19, wherein the solid support comprises a polymeric membrane.

23. The method of claim 19, wherein the at least one immunogen is selected from the group consisting of a virus, a viral surface protein or an immunogenic fragment thereof and a recombinant biomolecule comprising an immunogenic protein.

24. The method of claim 23, wherein the virus is selected from the group consisting of influenza virus, herpes simplex virus and human immunodeficiency virus.

25. The method of claim 24, wherein the viral surface protein is hemagglutinin.

26. The method of claim 19, wherein the negatively charged multivalent ion exchange group is selected from the group consisting of a sulfate group, a phosphate group and a borate group.

27. The method of claim 19, wherein the polymeric membrane comprises a synthetic polymer selected from the group consisting of polyethylene, polyvinylidine fluoride, polyethersulfone and combinations thereof.

28. A chromatography matrix for purification of an immunogen, wherein the matrix comprises a non-polysaccharide porous solid support comprising a negatively charged, multivalent ion exchange group attached to the solid support without the need for an extender.

29. The chromatography matrix of claim 28, wherein the solid support is a membrane.
